(19) United States
(12) Patent Application Publication
(10) Pub. No.: US 2026/0074328 A1
(43) Pub. Date: Mar. 12, 2026

(54) SECONDARY BATTERY, SECONDARY BATTERY CRIMPING DEVICE, AND CRIMPING METHOD USING THE SAME

(71) Applicant: SK ON CO., LTD., Seoul (KR)

(72) Inventor: Moon Hyung JUNG, Daejeon (KR)

(21) Appl. No.: 19/325,528

(22) Filed: Sep. 11, 2025

(30) Foreign Application Priority Data
Sep. 12, 2024 (KR) 10-2024-0124991

(51) Int. Cl. H01M 50/167; H01M 50/107; H01M 50/184; H01M 50/186

(52) U.S. Cl. CPC H01M 50/167; H01M 50/184; H01M 50/186; H01M 50/107

(57) ABSTRACT

The present disclosure relates to a secondary battery, a crimping device for a secondary battery, and a crimping method using the crimping device. A secondary battery according to various embodiments of the present disclosure comprises: a battery can configured to accommodate an electrode assembly; and a cap plate coupled to one side of the battery can, wherein the cap plate is in contact with and electrically connected to the battery can.

### CROSS-REFERENCE TO RELATED APPLICATION

This patent application claims the priority and benefits of Korean patent application No. 10-2024-0124991, filed on Sep. 12, 2024 the disclosure of which is incorporated herein by reference in its entirety.

### BACKGROUND

### 1. Field of the Invention

The present disclosure relates to a secondary battery, a crimping device for a secondary battery, and a crimping method using the crimping device.

### 2. Description of the Related Art

Secondary batteries are used as energy sources in electric vehicles or electronic devices. In the secondary battery, a jelly-roll-type electrode assembly, in which an anode plate, a cathode plate and a separator are wound together, is used, or alternatively, an electrode assembly fabricated by stacking an anode plate, a cathode plate and a separator in an appropriate order may be used.

This electrode assembly is accommodated in a housing and connected to an anode terminal and a cathode terminal. The housing is then sealed after being filled with an electrolyte.

### SUMMARY

According to an aspect of the present disclosure, there may be provided a secondary battery capable of improving sealing performance.

According to another aspect of the present disclosure, there may be provided a secondary battery capable of providing a diversified pathway for electron migration.

A secondary battery according to some embodiments of the present disclosure may comprise: a battery can configured to accommodate an electrode assembly; and a cap plate coupled to one side of the battery can, wherein the cap plate may be in contact with and electrically connected to the battery can.

In some embodiments, the secondary battery may further comprise a first electrode terminal disposed in a direction opposite to the opening part of the battery can based on the electrode assembly, wherein the cap plate may form a second electrode terminal having a different polarity from that of the first electrode terminal.

In some embodiments, the battery can may comprise a crimping part bent such that at least a partial section of a side wall thereof encloses at least a partial section of the cap plate.

In some embodiments, the cap plate may comprise: a body part disposed to cover an opening part of the battery can; and an edge part extending upward along a periphery of the body part and contacting the battery can.

In some embodiments, the crimping part may be disposed to enclose at least a portion of the edge part.

In some embodiments, the edge part may be bent one or more times.

In some embodiments, the edge part may comprise: a first edge part extending upward from the body part; and a second edge part bent inward from the first edge part and at least partly enclosed by the crimping part.

In some embodiments, the crimping part may comprise: a first horizontal part in contact with an upper surface of the second edge part; a vertical part extending downward from the first horizontal part; and a second horizontal part bent from the vertical part toward the side wall of the battery can and in contact with a lower surface of the first edge part.

In some embodiments, the second horizontal part may be in contact with an inner surface of the first edge part.

In some embodiments, the secondary battery may further comprise a sealing gasket disposed between the body part and the crimping part.

In some embodiments, the sealing gasket may be in contact with the second horizontal part of the crimping part.

In some embodiments, the sealing gasket may be disposed along an inner circumference of the edge part.

In some embodiments, the sealing gasket may comprise a ring shape.

In some embodiments, the sealing gasket may be pressed by the crimping part.

A crimping device according to some embodiments of the present disclosure may comprise: a mold support device; and a crimping mold lowered by the mold support device to apply a pressing force to an opening part of a battery can, wherein the crimping mold may press the battery can such that at least a partial section of the side wall of the battery can and at least a partial section of a cap plate disposed in the opening part of the battery can are bent.

In some embodiments, the crimping mold may comprise: a first mold configured to press an open end part of the side wall of the battery can to pre-form the side wall; and a second mold configured to press the pre-formed side wall of the battery can to form a crimping part.

In some embodiments, the crimping mold may further comprise a third mold configured to press the crimping part to compress a sealing gasket disposed on an upper portion of the cap plate.

In some embodiments, the first mold may comprise a pre-forming part formed on a lower surface thereof to have an upwardly concave curved surface in a vertical cross-section, and at least a partial section of the curved surface may comprise a direction-changing part configured to guide the open end part of the side wall of the battery can to be bent downward.

In some embodiments, the pre-forming part may comprise a semicircular shape in the vertical cross-section.

A crimping method according to some embodiments of the present disclosure may comprise: a preparation step of sequentially placing a cap plate and a sealing gasket on one side of a battery can; a first crimping step of pre-forming at least a partial section of a side wall of the battery can and at least a partial section of the cap plate to be bent together; a second crimping step of forming a crimping part such that the pre-formed side wall of the battery can is joined while enclosing the bent section of the cap plate, and the sealing gasket is disposed between an unbent section of the cap plate and the crimping part; and a third crimping step of pressing the crimping part to compress the sealing gasket by the crimping part.

According to various embodiments of the present disclosure, the secondary battery may be provided with an anode terminal without a separate attachment process by electrically connecting the cap plate to the battery can.

In addition, the cap plate may have a relatively larger area than that of a separately attached terminal, thereby providing a diversified pathway for electron migration.

Further, since not only the battery can but also the cap plate may function as an anode terminal, when forming a battery pack or directly arranging battery cells in a vehicle, the degree of freedom in the arrangement of the battery cells may be increased.

Further, in the present disclosure, the edge part of the cap plate, which is bent together with the side wall, may be hermetically joined to the crimping part through a hook-like shape on the inside of the crimping part, thereby ensuring excellent sealing performance without welding.

Furthermore, in the present disclosure, the sealing gasket disposed on an upper portion of the cap plate may be compressed by the crimping part, thereby further improving the sealing performance.

### BRIEF DESCRIPTION OF THE DRAWINGS

The above and other embodiments, features and other advantages of the present disclosure will be more clearly understood from the following detailed description taken in conjunction with the accompanying drawings, in which:

FIG. 1 is a cross-sectional view schematically illustrating a cylindrical secondary battery according to an exemplary embodiment of the present disclosure;

FIG. 2 is a partial cross-sectional view illustrating an initial arrangement structure of an opening part of a battery can according to an exemplary embodiment of the present disclosure;

FIGS. 3 to 5 are reference views for describing a sealing method using a crimping device according to various embodiments of the present disclosure; and

FIG. 6 is a flowchart of a crimping method according to various embodiments of the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe his or her invention, they should be interpreted based on the meanings and concepts that meet the technical ideas of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply that the presence of the corresponding component, and thus should not be interpreted to exclude the presence of other components but rather to include them.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component with another component possibly interposed.

Space-related terms such as “beneath,” “below,” “lower,” “above,” and “upper” may be used to facilitate understanding of the relationship between an element or feature and another element or feature illustrated in the drawings. These space-related terms are provided to facilitate understanding of the present disclosure in their various process or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” or “below” depending on orientation.

The embodiments described in this specification and the configurations illustrated in the drawings merely represent the most preferred embodiments of the present disclosure but do not encompass all technical ideas of the present disclosure. Thus, it should be understood that various modifications and equivalents may be implemented at the time of filing the present application. In addition, the publicly known functions and configurations that are deemed unnecessary for clarifying the essence of the present invention will not be described.

Hereinafter, a cylindrical secondary battery 1 according to various embodiments of the present disclosure will be described in detail with reference to the accompanying drawings.

The secondary battery 1 described in the present disclosure may be any type of conventional battery cell capable of converting the chemical energy of materials stored in the battery into electrical energy, and capable of supporting multiple charge/discharge cycles.

In describing various embodiments of the present disclosure, the axial direction may refer to a direction in which a central axis extends, along which a jelly-roll-shaped electrode assembly 10 is wound, or a direction in which a central axis of a battery can 100, coaxially aligned with the former, extends. The radial direction may refer to a direction extending toward or away from the central axis.

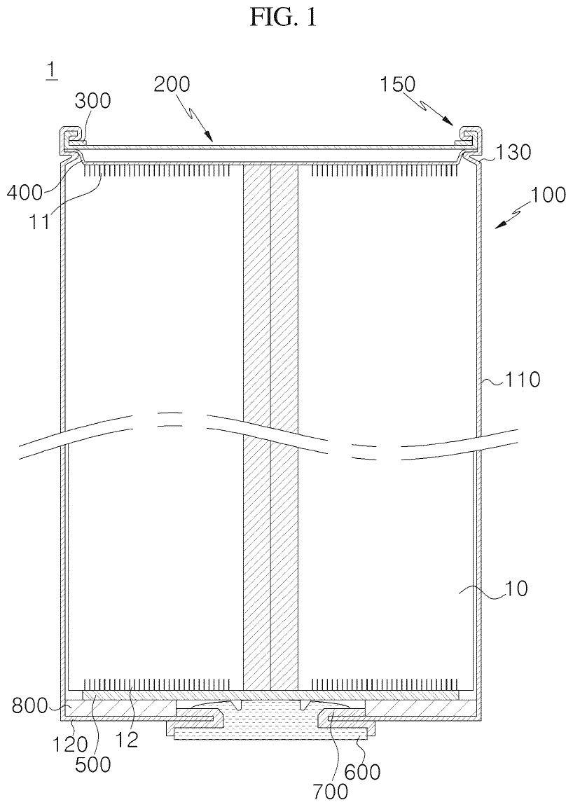

FIG. 1 is a cross-sectional view schematically illustrating the cylindrical secondary battery 1 according to an exemplary embodiment of the present disclosure.

Referring to FIG. 1, the secondary battery 1 according to an exemplary embodiment of the present disclosure may comprise the electrode assembly 10, the battery can 100, a cap plate 200, a sealing gasket 300 and an upper current collector plate 400.

In addition, the secondary battery 1 may further comprise an electrode terminal 600, a terminal gasket 700, an insulator 800 and a lower current collector plate 500.

First, the electrode assembly 10 may comprise a first electrode plate (not shown), a second electrode plate (not shown) and a separator (not shown).

The first electrode plate may be either a cathode plate or an anode plate. For example, the first electrode plate may be an anode plate. In an exemplary embodiment, the first electrode plate may comprise an anode current collector in the form of a metal foil and an anode coating layer formed by applying an anode active material to the anode current collector. For example, the anode current collector may comprise copper or nickel.

In an exemplary embodiment, the anode coating layer may be an electrically conductive coating, and may comprise an anode active material. For example, the anode active material may comprise a silicon material (e.g., metallic silicon and silicon dioxide), a carbon-based material (e.g., graphite materials, graphene-containing materials, hard carbon, soft carbon, carbon nanotubes, porous carbon, or conductive carbon), a tin-based material, or a metal oxide, but it is not limited thereto, and any anode active material known to those skilled in the art may be used.

In an exemplary embodiment, the first electrode plate may comprise a first electrode coated part on which an anode coating layer is formed on the anode current collector and a first electrode uncoated part 11, in which no anode coating layer is formed.

The second electrode plate may be either a cathode plate or an anode plate. When the second electrode plate is a cathode plate, the first electrode plate may be an anode plate, and when the second electrode plate is an anode plate, the first electrode plate may be a cathode plate.

For example, the second electrode plate may be a cathode plate. In an exemplary embodiment, the second electrode plate may comprise a cathode current collector in the form of a metal foil and a cathode coating layer formed by applying a cathode active material to the cathode current collector. For example, the cathode current collector may comprise aluminum.

In an exemplary embodiment, the cathode coating layer may be an electrically conductive coating, and may comprise a cathode active material. For example, the cathode active material may comprise lithium nickel manganese cobalt oxide (NMC), lithium manganese oxide (LMO), lithium iron phosphate (LFP), lithium cobalt oxide (LCO), lithium titanate (LTO), or a chalcogenide compound (such as LiTiS₂), but it is not limited thereto, and any cathode active material known to those skilled in the art may be used.

In an exemplary embodiment, the second electrode plate may comprise a second electrode coated part on which a cathode coating layer is formed on the cathode current collector and a second electrode uncoated part 12, in which no cathode active material is formed on the cathode current collector.

The separator may be interposed between the first electrode plate and the second electrode plate to prevent the first electrode plate and the second electrode plate from being electrically connected to each other and causing a short circuit. In an exemplary embodiment, the separator may comprise an electrically insulating material. For example, the separator may comprise a polymeric material. For example, the separator may comprise polyethylene, polypropylene, or a combination thereof, but it is not limited thereto.

The electrode assembly 10 may be wound in a jelly-roll shape by stacking the above-described first electrode plate, the separator, and the second electrode plate. In an exemplary embodiment, the first electrode uncoated part 11 and the second electrode uncoated part 12 may be exposed at opposite axial ends of the electrode assembly 10 to define electrode tabs.

In the present disclosure, a tabless structure may be used in which the uncoated parts of the first electrode plate and the second electrode plate serve as electrode tabs without the need for separate electrode tabs, but it is not limited thereto, and it is obvious that a structure in which separate electrode tabs are connected to the first electrode plate and the second electrode plate may also be employed.

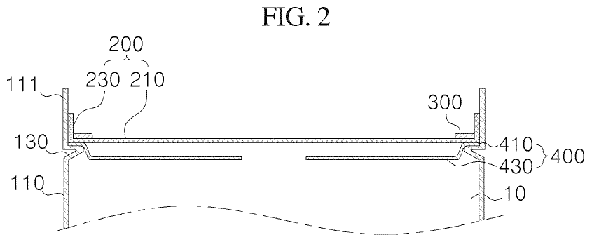

The battery can 100 may have an opening part formed at at least one axial end thereof so that the electrode assembly 10 can be accommodated through the opening part of the battery can 100. The battery can 100 may have an internal space formed therein to accommodate the electrode assembly 10. Here, as an example, an upper end of the battery can 100 is described as being open as shown in FIG. 2, but it is obvious that the opposite configuration may also be employed.

The battery can 100 may comprise a conductive metal material. The battery can 100 may be electrically connected to either the first electrode plate or the second electrode plate.

The shape of the battery can 100 may be determined to correspond to the specific shape of the electrode assembly 10. For example, the battery can 100 may be cylindrical or have a rectangular parallelepiped structure.

The battery can 100 may comprise the opening part formed at an upper axial end, a lower wall 120 formed at an axial end opposite to the opening part, and a side wall 110 connecting the opening part and the lower wall 120. In an exemplary embodiment, the electrode terminal 600 may be disposed on the lower wall 120 of the battery can 100.

The structure of the secondary battery 1 on a lower side of the electrode assembly 10 will be described first.

The electrode terminal 600 may be disposed by passing through a terminal hole formed in the lower wall 120 of the battery can 100. The electrode terminal 600 may be electrically connected to a lower current collector plate 500. The electrode terminal 600 may be electrically connected to the lower current collector plate 500 and serve as the electrode terminal 600 of the secondary battery 1 of the present disclosure. Here, the electrode terminal 600 disposed on the lower wall 120 of the battery can 100 may be described as a first electrode terminal. For example, the electrode terminal 600 or the first electrode terminal may be a cathode terminal.

In an exemplary embodiment, the electrode terminal 600 may be provided in a rivet shape, as shown in FIG. 1. For example, the electrode terminal 600 may be fixed to the lower wall 120 of the battery can 100 by passing through a terminal hole formed in the lower wall.

The electrode terminal 600 may be electrically connected to the first electrode plate or the second electrode plate of the electrode assembly 10. For example, the electrode terminal 600 may be directly connected to the second electrode plate, or may be connected to the second electrode plate through the lower current collector plate 500.

The electrode terminal 600 may be disposed so as to be electrically insulated from the lower wall 120 of the battery can 100. The electrode terminal 600 and the battery can 100 may have different polarities.

An upper end portion of the electrode terminal 600 may be connected to the lower current collector plate 500 through a hollow portion of the insulator 800. The upper end portion of the electrode terminal 600 may be fixed while being exposed to the outside of the battery can 100 and insulated from the lower wall 120 of the battery can 100 by the terminal gasket 700.

In FIG. 2, the electrode terminal 600 is exemplarily shown as installed in the rivet shape, but it is not limited thereto, and it is obvious that any known type of electrode terminal 600 may be applied.

The terminal gasket 700 may be interposed between the electrode terminal 600 and the battery can 100. The terminal gasket 700 may prevent the electrode terminal 600 from coming into direct contact with the battery can 100. For example, the terminal gasket 700 may be formed of an insulating material. The terminal gasket 700 may electrically insulate the electrode terminal 600 from the battery can 100.

For example, the terminal gasket 700 may comprise an elastic material. As an example, when the electrode terminal 600 is installed in the terminal hole through riveting, the terminal gasket 700 may be deformed by the force applied thereto. In this case, an elastic restoring force may be generated in the terminal gasket 700, and the terminal gasket 700 may be interposed and thereby fixed between the electrode terminal 600 and the battery can 100.

In addition, the terminal gasket 700 may maintain airtightness when the electrode terminal 600 is installed in the terminal hole of the lower wall 120 of the battery can 100.

The lower current collector plate 500 may be disposed adjacent to the upper end portion of the electrode assembly 10 inside the battery can 100. For example, the lower current collector plate 500 may be disposed adjacent to the second electrode uncoated part 12 of the second electrode plate. The lower current collector plate 500 may be electrically connected to the second electrode plate thereby providing a pathway for electron migration. In an exemplary embodiment, the lower current collector plate 500 may be a cathode current collector.

The lower current collector plate 500 may be electrically connected to the electrode terminal 600. The lower current collector plate 500 may be electrically connected to the upper end portion of the electrode terminal 600 and the second electrode plate of the electrode assembly 10 thereby providing a pathway for electron migration.

For example, the lower current collector plate 500 may be in direct contact with a lower end portion of the electrode terminal 600 and the second electrode uncoated part 12. For example, the lower current collector plate 500 may be electrically connected to the lower end portion of the electrode terminal 600 and the second electrode uncoated part 12, respectively, through a conductive member.

The lower current collector plate 500 may be provided in a shape corresponding to the lower surface of the electrode assembly 10. For example, the lower current collector plate 500 may be a circular metal plate.

The lower current collector plate 500 may be disposed so as to be electrically insulated from the battery can 100, and the lower current collector plate 500 and the battery can 100 may have different polarities. The lower current collector plate 500 may be electrically insulated from the side wall 110 and the outer wall of the battery can 100 by the insulator 800.

The insulator 800 may be disposed so as to be electrically insulated from the battery can 100. In the secondary battery 1, the insulator 800 may be interposed between the lower current collector plate 500 and the battery can 100, so that the lower current collector plate 500 and the battery can 100 may be electrically insulated.

The insulator 800 may be disposed between the lower current collector plate 500 and the lower wall 120 of the battery can 100, thereby preventing the lower current collector plate 500 from contacting the lower wall 120 or side wall 110 of the battery can 100.

Alternatively, if the lower current collector plate 500 is omitted and the electrode terminal 600 is directly connected to the second electrode uncoated part 12, the insulator 800 may be disposed between the second electrode uncoated part 12 of the electrode assembly 10 and the lower wall 120 of the battery can 100.

In an exemplary embodiment, the insulator 800 may have a hollow circular plate shape. For example, the electrode terminal 600 may be electrically connected to the lower current collector plate 500 by passing through the hollow portion of the insulator 800.

Next, the structure of the secondary battery 1 on an upper side of the electrode assembly 10 will be described in detail.

In the secondary battery 1 of the present disclosure, an electrolyte may be injected into the battery can 100 together with the electrode assembly 10 through the opening during the manufacturing process. In this case, the electrolyte serves as a medium for the migration of lithium ions between the second electrode plate and the first electrode plate forming the electrode assembly 10. For example, the electrolyte may be a non-aqueous organic electrolyte that is a mixture of a lithium salt and a high-purity organic solvent. For example, the electrolyte may be a polymer using a polymer electrolyte or solid electrolyte.

Meanwhile, in the manufacturing process of the secondary battery 1, after the electrode assembly 10 is received inside the battery can 100, a beading part 130 may be formed by recessing a partial section of the side wall 110 of the battery can inward toward the center. The battery can 100 may apply a physical fixing force to the electrode assembly 10 accommodated therein through the beading part 130. In another embodiment, a method for fixing the electrode assembly 10 through the arrangement of internal components of the electrode assembly 10 may be applied to the secondary battery, without forming the beading part 130 in the battery can 100.

Meanwhile, the battery can 100 may be sealed by the cap plate 200 in a state where the opening part of the battery can 100 is positioned and the upper current collector plate 400 is disposed at the upper portion of the assembly.

First, the upper current collector plate 400 may be disposed adjacent to the upper end portion of the electrode assembly 10 inside the battery can 100. For example, the upper current collector plate 400 may be disposed adjacent to the first electrode uncoated part 11 of the first electrode plate inside the battery can 100.

The upper current collector plate 400 may be electrically connected to the first electrode plate thereby providing a pathway for electron migration. The upper current collector plate 400 may be provided in a shape corresponding to the upper surface of the electrode assembly 10. For example, the upper current collector plate 400 may have a circular metal structure. For example, the upper current collector plate 400 may have a hollow circular plate shape.

In an exemplary embodiment, the upper current collector plate 400 may be an anode current collector plate. The upper current collector plate 400 may be electrically connected to the first electrode plate through the first electrode uncoated part 11. For example, the upper current collector plate 400 may be in direct contact with the first electrode uncoated part 11.

For example, the upper current collector plate 400 may be coupled to the first electrode uncoated part 11 through pressing, soldering, laser welding, or the like, but it is not limited thereto. For example, the upper current collector plate 400 may be electrically connected to the first electrode uncoated part 11 through a conductive member.

In an exemplary embodiment, the upper current collector plate 400 may be disposed to be electrically connected to the battery can 100. The upper current collector plate 400 may have the same polarity as the battery can 100. For example, the battery can 100 may have a negative polarity and may serve as an anode terminal.

For example, the upper current collector plate 400 may comprise an electrode connection part 410, which is coupled to the first electrode uncoated part 11, and a battery can connection part 430 formed around the electrode connection part 410 and connected to the battery can 100.

The battery can connection part 430 may be seated on the beading part 130 formed by recessing a partial section of the side wall 110 of the battery can 100 inward toward the center.

The cap plate 200 may be coupled to the opening part of the battery can 100 to seal the opening part of the battery can 100.

According to various embodiments of the present disclosure, the cap plate 200 may be electrically connected to the battery can 100 and may have the same polarity as the battery can 100. The cap plate 200 may be made of a conductive metal. Here, the cap plate 200 may be described as a second electrode terminal having a different polarity from that of the above-described first electrode terminal. For example, the cap plate 200 or the second electrode terminal may be in direct contact with the battery can 100 and function as an anode terminal together with the battery can 100.

Generally, in a structure in which the cap plate 200 is insulated from the battery can 100, a separate anode terminal must be attached to the lower wall 120 or the side wall 110 of the battery can 100. However, if the anode terminal is attached to the lower wall 120 of the battery can 100, there is a risk of short circuit because it is located adjacent to a cathode terminal disposed on the lower wall 120. In addition, when the anode terminal is attached to the side wall 110 of the battery can 100, there is a risk of the terminal becoming detached due to the weakened adhesion caused by the curvature of the side wall 110.

In contrast, in the present disclosure, by electrically connecting the cap plate 200 to the battery can 100 through contact, an anode terminal may be provided without a separate attachment process. In addition, the cap plate 200 may have a relatively larger area than that of a separately attached terminal, thereby providing a diversified pathway for electron migration. In addition, since the cap plate 200 as well as the battery can 100 may function as the anode terminal, when forming a battery pack or directly arranging battery cells in a vehicle, the degree of freedom in the arrangement of battery cells may be increased.

The cap plate 200 may be formed in a shape corresponding to the opening part of the battery can 100. For example, the cap plate 200 may have a generally circular plate shape. In an exemplary embodiment of the present disclosure, an outer peripheral end of the cap plate 200 may be bent together with the side wall 110 while being in contact with the side wall 110 of the opening part of the battery can 100 to form a crimping part 150.

More specifically, the cap plate 200 may comprise a body part 210 having a shape corresponding to the opening part of the battery can 100 and an edge part 230 extending upward along the periphery of the body part 210.

The body part 210 has a shape corresponding to the opening part of the battery can 100 and may be seated on one side of the battery can. For example, the body part 210 may be seated on the beading part 130 of the battery can 100. For example, the body part 210 may be mounted on the upper portion of the upper current collector plate 400 in a state where the battery can connection part 430 of the upper current collector plate 400 is seated on the beading part 130. The body part 210 may be disposed to cover the opening part of the battery can 100.

In an exemplary embodiment, the body part 210 may comprise at least one terminal part (not shown). The terminal part may be disposed to axially protrude upward from one side of the body part 210. For example, the terminal part may be disposed coaxially with the central axis of the battery can in the body part 210, but it is not limited thereto. The secondary battery of the present disclosure may be easily connected to an external component (e.g., a bus bar, not shown) through the terminal part, and may provide a path for electron movement.

In an exemplary embodiment, at least one notch part (not shown) may be disposed on one side of the body part 210 to facilitate fracture when the internal pressure of the battery can increases. For example, the notch part may be provided in the form of a groove formed concavely to a predetermined depth on at least one surface of the upper or lower surface of the body part 210. For example, the notch part may be formed in the terminal part, but it is not limited thereto.

The cap plate 200 may be in contact with the side wall 110 of the battery can 100 through the edge part 230. The edge part 230 may be in surface contact with the side wall 110 of the battery can 100. The edge part 230 may be bent together with the side wall 110 at least in a partial section of the upper end portion to form the crimping part 150. The edge part 230 may be disposed to be enclosed by a partial section of the open end part 111 of the side wall 110 forming the opening part.

More specifically, the edge part 230 may comprise a vertical edge part 231 extending upwardly from the body part 210 and a horizontal edge part 233 extending radially inwardly from the vertical edge part 231. Here, the vertical edge part 231 may be described as a first edge part, and the horizontal edge part 233 may be described as a second edge part.

The horizontal edge part 233 may be formed by being bent together during the process in which an upper partial section of the side wall 110 is bent inward by a crimping mold 900 according to an exemplary embodiment of the present disclosure. For example, the edge part 230 may be bent one or more times.

An outer surface of the vertical edge part 231 may be in contact with the inner surface of the side wall 110, and the inner surface of the vertical edge part 231 may be in contact with the second horizontal part 155 of the side wall 110. That is, the inner surface of the vertical edge part 231 may be in contact with the upper end surface of the side wall 110.

The horizontal edge part 233 may be enclosed by the side wall 110 of the battery can 100. For example, an upper surface of the horizontal edge part 233 may be in contact with the first horizontal part 151 of the side wall 110, a lower surface of the horizontal edge part 233 may be in contact with the second horizontal part 155 of the side wall 110, and the end surface of the horizontal edge part 233 may be in contact with the vertical part 153 of the side wall 110.

Meanwhile, at least a partial upper section of the side wall 110 forming the opening part of the battery can 100 may be pressed and bent by the crimping mold 900 to form the crimping part 150. The crimping part 150 may be formed on an upper portion of the beading part 130. The crimping part 150 may be bent together with the edge part 230 while enclosing the edge part 230 on the inside to form the crimping part 150. A specific process for forming the crimping part 150 in the present disclosure will be described below.

More specifically, the crimping part 150 may comprise a first horizontal part 151 extending toward the center of the electrode assembly 10, formed by bending the side wall 110 inward in the radial direction, a vertical part 153 extending downward from the first horizontal part 151 to approach the electrode assembly 10, and a second horizontal part 155 extending toward the side wall 110 of the battery can 100 from the vertical part 153.

Sealing of the battery can 100 may be performed in a state where at least a partial section of the edge part 230 of the cap plate 200 is disposed on the inside of the crimping part 150, and the crimping part 150 encloses the edge part 230. Specifically, a lower surface of the first horizontal part 151 may be in contact with the upper surface of the horizontal edge part 233, and an upper surface of the second horizontal part 155 may be in contact with the lower surface of the horizontal edge part 233. The inner surface of the vertical part 153 may be in contact with the end surface of the horizontal edge part 233. Additionally, the end surface of the second horizontal part 155 may be in contact with the inner surface of the vertical edge part 231.

In the present disclosure, the sealing performance of the can may be improved without welding by compressing the edge part 230 while it is enclosed by the crimping part 150.

Meanwhile, the sealing gasket 300 may be disposed between the crimping part 150 and the cap plate 200 to further improve the sealing performance. The sealing gasket 300 may be interposed between the cap plate 200 and the crimping part 150 of the side wall 110 to maintain airtightness. The sealing gasket 300 may be pressed by the crimping part.

In an exemplary embodiment, the sealing gasket 300 may be provided in a ring shape. The sealing gasket 300 may be provided in the ring shape having a predetermined thickness in the axial direction and an extended length in the radial direction. The sealing gasket 300 may be disposed along the inner circumference of the edge part 230 of the cap plate 200 on the body part 210 of the cap plate 200. The sealing gasket 300 may be formed of an elastic material.

The sealing gasket 300 may be interposed between the second horizontal part 155 of the crimping part 150 and the body part 210 of the cap plate 200. An upper surface of the sealing gasket 300 may be in contact with the second horizontal part 155 of the crimping part 150, and a lower surface of the sealing gasket 300 may be in contact with the upper surface of the body part 210 of the cap plate 200. In addition, the outer surface of the sealing gasket 300 may be in contact with the inner surface of the vertical edge part 231.

That is, the present disclosure provides a structure in which the sealing gasket 300 is interposed between an outer surface of the side wall 110 of the battery can 100 and the cap plate 200.

The sealing gasket 300 may be compressed by the crimping part 150 while its upper surface, lower surface, and inner surface are in contact with the crimping part 150, the body part 210 of the cap plate 200, and the edge part 230, respectively, thereby maintaining airtightness.

The present disclosure enables the battery can 100 to be sealed without welding while having a structure in which the battery can 100 and the cap plate 200 are in direct contact.

In the manufacturing process of the present disclosure, the secondary battery 1 has a structure in which the open end part 111 of the side wall 110 is bent together with the edge part 230 of the cap plate 200 to enclose the edge part 230, thereby ensuring the sealing performance of the battery can 100 without welding while the edge part 230 of the cap plate 200 is in contact with the side wall 110. In addition, the sealing performance may be further improved by pressing the sealing gasket 300 against the body part 210 of the cap plate 200 through the bent crimping part 150 of the side wall 110.

Hereinafter, a crimping device according to various embodiments of the present disclosure will be described in detail with reference to the accompanying drawings.

FIG. 2 is a partial cross-sectional view illustrating an initial arrangement structure of an opening part of the battery can 100 according to an exemplary embodiment of the present disclosure.

Referring to FIG. 2, in order to perform a crimping process in the secondary battery 1 according to various embodiments of the present disclosure, an upper current collector plate 400, the cap plate 200, and the sealing gasket 300 may be sequentially disposed on the beading part 130 of the battery can 100.

For example, when the electrode connection part 410 of the upper current collector plate 400 is welded to the first electrode plate of the electrode assembly 10, the battery can connection part 430 of the upper current collector plate 400 may be seated on the beading part 130 while the electrode assembly 10 is accommodated inside the battery can 100.

As described above, the cap plate 200 may comprise the body part 210 and the edge part 230 extending upward along the periphery of the body part 210. When the body part 210 of the cap plate 200 is seated on the upper current collector plate 400, the edge part 230 may come into contact with the side wall 110 of the battery can 100. At this time, the upper end portion of the edge part 230 may be positioned lower than the open end part 111 of the side wall 110 of the battery can 100.

In the present disclosure, since the open end part 111 of the side wall 110 is positioned higher than the upper end portion of the edge part 230, when the crimping mold 900 is lowered, the side wall 110 positioned on the outside is pressed first, and the edge part 230 positioned on the inside may be pressed by the side wall 110.

A ring-shaped sealing gasket 300 may be placed on the upper portion of the cap plate 200. At this time, the sealing gasket 300 may be positioned along the inner circumference of the edge part 230, and may be arranged so that the outer surface of the sealing gasket 300 comes into contact with the inner surface of the edge part 230.

As described above, when the cap plate 200 and the sealing gasket 300 are disposed on the opening part of the battery can 100, a crimping process may be performed thereafter.

The crimping process may be performed by the crimping device according to various embodiments of the present disclosure. The crimping device is a device for sealing the battery can 100 of the secondary battery 1 by pressing and bending the upper end portion of the secondary battery 1 after the preparation step has been completed.

The crimping device may comprise the crimping mold 900 and a mold support device (not shown) for supporting the crimping mold 900 while lowering it toward the lower side of the battery can 100 from the top.

The crimping mold 900 according to various embodiments of the present disclosure may comprise a first mold 900a configured to press the open end part 111 of the side wall 110 of the battery can 100 so that the side wall 110 approaches a form that encloses the edge part 230 by gradually inclining it toward the central axis of the battery can 100, and a second mold 900b configured to form the first horizontal part 151, the vertical part 153 and the second horizontal part 155 in the side wall 110 in the shape in which the side wall 110 encloses the edge part 230. In addition, the crimping mold 900 may further comprise a third mold 900c configured to press the sealing gasket 300 through the crimping part 150.

The first to third molds 900a to 900c of the crimping device may be provided to rotate and descend around the central axis of the battery can 100 by the mold support device.

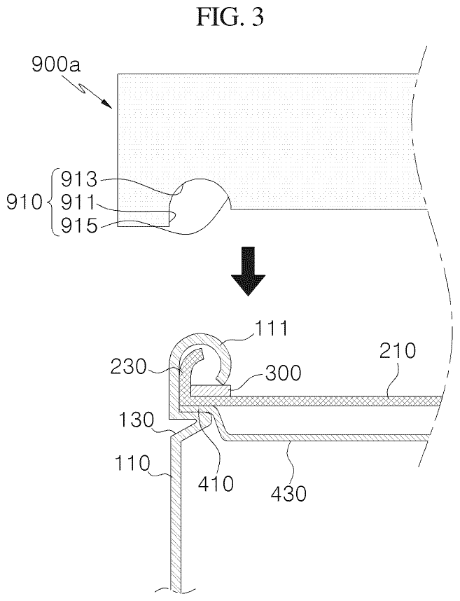

FIGS. 3 to 5 are reference views for describing a sealing method using the crimping device according to various embodiments of the present disclosure.

Referring to FIG. 3, the first mold 900a may be lowered toward the lower side of the battery can 100 from the top while the central axis of the first mold 900a is aligned with that of the battery can 100.

At this time, a lower surface of the first mold 900a facing the opening part of the battery can 100 may comprise a pre-forming part 910 formed to have an upwardly concave curved surface in a vertical cross-section. Here, the process of molding using the pre-forming part 910 of the first mold 900a may be described as a pre-forming process.

For example, the pre-forming part 910 may be formed to have a semicircular shape in the vertical cross-section. The pre-forming part 910 may comprise an entry part 911 formed at the outermost side of the semicircular shape, a direction-changing part 913 formed at the top of the semicircular shape, and a finishing part 915 formed at the innermost side of the semicircular shape.

When the first mold 900a presses the opening part of the battery can 100 downward from the top, the open end part 111 of the side wall 110 may be gradually inclined toward the central axis of the battery can 100 along the curved surface of the pre-forming part 910.

First, the open end part 111 of the side wall 110 comes into contact with the entry part 911 of the pre-forming part 910 and begins to incline along the curved surface, and may be gradually inclined toward the central axis of the battery can 100 up to the direction-changing part 913.

Thereafter, as the first mold 900a continues to descend, the open end part 111 of the side wall 110 may be gradually guided and bent toward the electrode assembly 10 while passing through the direction-changing part 913.

For example, the open end part 111 of the side wall 110 may be bent so that at least a partial section is oriented away from the central axis of the battery can 100 while passing through the finishing part 915.

Meanwhile, the edge part 230 of the cap plate 200 may be bent together with the open end part 111 of the side wall 110 as it is pressed and bent by the first mold 900a. At least a partial section of the upper end portion of the edge part 230 may be pressed by the open end part 111 of the side wall 110 and inclined together with it. At this time, a partial section of the upper end portion of the edge part 230 may be enclosed by the open end part 111 of the side wall 110 while the portion is inclined inward.

As the first mold 900a is lowered, the open end part 111 of the side wall 110 may be bent along the entry part 911, the direction-changing part 913 and the finishing part 915 by the applied pressing force, so as to be in a state adjacent to the sealing gasket 300. Here, the process of being pressed by the pre-forming part 910 of the first mold 900a may be described as a first crimping step.

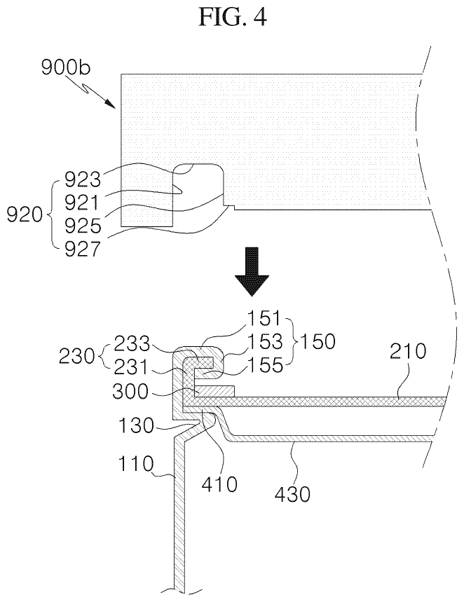

Referring to FIG. 4, after the first crimping step is completed, in a second crimping step, a pressing force may be applied to the battery can 100 by the second mold 900b. The second mold 900b may be lowered toward the lower side of the battery can 100 from the top while the central axis of the second mold 900b is aligned with that of the battery can 100.

At this time, a lower surface of the second mold 900b facing the opening part of the battery can 100 may comprise a main forming part 920 that is concave upward in the vertical cross section.

For example, the main forming part 920 may comprise a first vertical forming part 921 in contact with the side wall 110 in the vertical cross-section, a first horizontal forming part 923 configured to form the first horizontal part 151 of the crimping part 150, and a second vertical forming part 925 configured to form the vertical part 153 of the crimping part 150. In addition, the second vertical forming part 925 may further comprise a step part 927 formed at an end thereof in the vertical cross-section to prevent interference with the sealing gasket 300.

When a pressing force is applied to the pre-formed side wall 110 as the second mold 900b is lowered, the pre-formed side wall 110 may be pressed and formed so that the side wall 110 encloses the edge part 230 according to the shape of the main forming part 920 of the second mold 900b.

In the second crimping step, the horizontal edge part 233 may be formed together, in which a partial section of the upper end portion of the edge part 230 is bent inward toward the central axis of the battery can 100. The horizontal edge part 233 may be formed by bending the partial section of the upper end portion of the edge part 230 into a hook-like shape.

In addition, the side wall 110 may be formed in a shape in which the side wall 110 encloses and is joined to the horizontal edge part 233 by forming the first horizontal part 151 in contact with the upper surface of the horizontal edge part 233, the vertical part 153 in contact with the end surface of the horizontal edge part 233, and the second horizontal part 155 in contact with the lower surface of the horizontal edge part 233.

In the present disclosure, the crimping part 150 is tightly joined to the outer side of the edge part 230, which is bent into a hook-like shape, so that the sealing performance of the battery can 100 may be improved compared to the conventional crimping structure.

Meanwhile, the sealing gasket 300 may be disposed between the body part 210, which is an unbent section of the cap plate 200, and the crimping part 150. For example, the second horizontal part 155 of the crimping part 150 may be disposed adjacent to the sealing gasket 300.

At this time, the second horizontal part 155 of the crimping part 150 may not form sufficient adhesion force with the sealing gasket 300, but the sealing performance may be improved by sufficiently compressing the sealing gasket 300 by the crimping part 150 through a third crimping step thereafter. In FIG. 4, it should be noted that the distance between the crimping part 150 and the sealing gasket 300 is intentionally exaggerated to aid understanding.

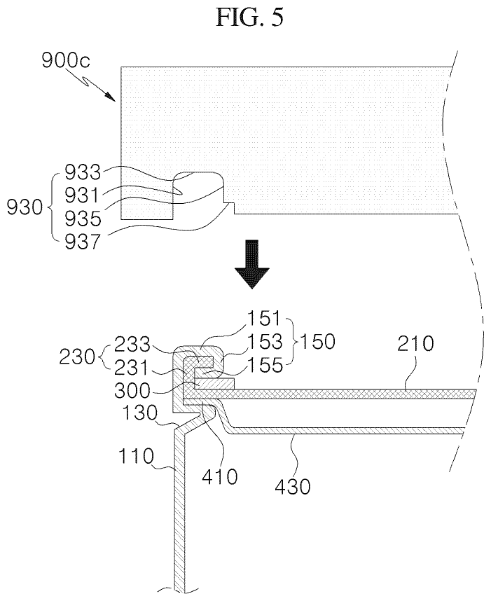

Referring to FIG. 5, in the third crimping step, a pressing force may be applied to the battery can 100 by the third mold 900c. The third mold 900c may be lowered toward the lower side of the battery can 100 from the top while the central axis of the third mold 900c is aligned with that of the battery can 100.

A lower surface of the third mold 900c facing the opening part of the battery can 100 may comprise a main forming part 930 that is concave upward in the vertical cross section. The shape of the main forming part 930 is the same as the main forming part 920 of the second mold 900b, but there is a difference in the concavity depth.

For example, the main forming part 930 may comprise a first vertical forming part 931 in contact with the side wall 110 in the vertical cross-section, a first horizontal forming part 933 configured to form the first horizontal part 151 of the crimping part 150, and a second vertical forming part 935 configured to form the vertical part 153 of the crimping part 150. In addition, the second vertical forming part 935 may further comprise a step part 937 formed at an end thereof in the vertical cross-section to prevent interference with the sealing gasket 300.

For example, the concavity depth of the first horizontal forming part 933 of the main forming part 930 of the third mold 900c may be shallower than that of the first horizontal forming part 923 of the main forming part 920 of the second mold 900b.

When a pressing force is applied to the battery can 100 through the third mold 900c, the crimping part 150 of the side wall 110 may be pressed downward to come into tight contact with the sealing gasket 300. In the process of the crimping part 150 coming into tight contact with the sealing gasket 300, the first horizontal part 151, the vertical part 153, and the second horizontal part 155 of the crimping part 150 may be hermetically joined with the horizontal edge part 233.

In the present disclosure, the crimping part 150 of the side wall 110 is bent to form the first horizontal part 151, the vertical part 153 and the second horizontal part 155, thereby forming a structure that tightly encloses the horizontal edge part 233, which is bent together on the inside, to structurally ensure sealing performance.

In addition, in the present disclosure, the second horizontal part 155 of the crimping part 150 may compress the sealing gasket 300, thereby further enhancing the sealing performance. This may be a structure that ensures sealing performance by compressing the sealing gasket 300 disposed between the body part 210 of the cap plate 200 and the outer surface of the side wall 110 of the battery can 100.

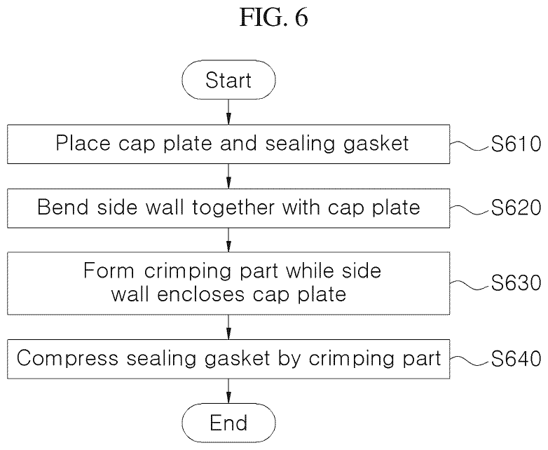

FIG. 6 is a flowchart of a crimping method according to various embodiments of the present disclosure.

The secondary battery 1 according to various embodiments of the present disclosure may be sealed through the above-described crimping device.

First, in the preparation step, the cap plate 200 and the sealing gasket 300 may be placed on one side of the battery can 100 (S610). For example, in the preparation step, the cap plate 200 and the sealing gasket 300 may be placed on the beading part 130 of the battery can 100.

Pre-molding for forming the crimping part 150 may be performed, in which, as the first mold 900a is lowered toward the lower side of the battery can 100 from the top, a pressing force is applied to the open end part 111 of the side wall 110 through the pre-forming part 910, so that the open end part 111 of the side wall 110 is bent along the entry part 911, the direction-changing part 913 and the finishing part 915 (S620).

A partial section of the upper end portion of the edge part 230 is pressed by the side wall 110 and begins to incline inward, and the side wall 110 may be bent downward so that the upper end portion thereof encloses the edge part 230 and is adjacent to the sealing gasket 300.

At this time, the side wall 110 is inclined and presses the edge part 230 of the cap plate 200, which is disposed adjacent to the inner side of the side wall 110, so that the side wall 110 and the edge part 230 of the cap plate 200 may be bent together.

As the second mold 900b is lowered toward the lower side of the battery can 100 from the top, the crimping part 150 including the first horizontal part 151, the vertical part 153 and the second horizontal part 155 may be formed at the open end part 111 of the side wall 110 (S630).

Specifically, a downward pressing force may be applied to the bent side wall 110 by the first horizontal forming part 923, thereby forming the first horizontal part 151. At this time, the side wall 110 may be prevented from deforming outward by the first vertical forming part 921, and the vertical part 153 may be formed by the second vertical forming part 925. In this case, the end of the side wall 110 may be pressed between the sealing gasket 300 and the first horizontal forming part 923 by the downward pressure, thereby forming the second horizontal part 155. Here, the open end part 111 of the side wall 110 may be joined while enclosing the horizontal edge part 233 of the cap plate 200, thereby forming the crimping part 150.

In the present disclosure, the edge part 230 of the cap plate 200, which is bent together with the side wall 110, may be hermetically joined to the crimping part 150 on the inside of the crimping part 150 through a hook-like shape, thereby ensuring excellent sealing performance without welding.

Thereafter, as the third mold 900c is lowered toward the lower side of the battery can 100 from the top, the crimping part 150 is pressed downward to compress the sealing gasket 300 disposed on the upper portion of the cap plate 200 (S640).

In the present disclosure, the sealing gasket 300 may be elastically deformed between the cap plate 200 and the crimping part 150, thereby further improving the sealing performance of the battery can 100.

As described above, in the secondary battery 1 according to various embodiments of the present disclosure, the cap plate 200 may be in direct contact with the battery can 100, thereby serving as the electrode terminal 600 while having the same polarity as the battery can 100.

In the present disclosure, by electrically connecting the cap plate 200 to the battery can 100 through contact, an anode terminal may be provided without a separate attachment process. In addition, the cap plate 200 may have a relatively larger area than that of a separately attached terminal, thereby providing a diversified pathway for electron migration. In addition, since the cap plate 200 as well as the battery can 100 may function as the anode terminal, when forming a battery pack or directly arranging battery cells in a vehicle, the degree of freedom in the arrangement of battery cells may be increased.

In the present disclosure, the edge part 230 of the cap plate 200, which is bent together with the side wall 110, may be hermetically joined to the crimping part 150 on the inside of the crimping part 150 through the hook-like shape, thereby ensuring excellent sealing performance without welding.

Further, in the present disclosure, the sealing gasket 300 disposed on the upper portion of the cap plate 200 may be compressed by the crimping part 150, thereby further improving the sealing performance.

In the above, although the embodiments of the present disclosure have been described with all components combined in one or operating in combination, the present disclosure is not necessarily limited to such embodiments. Within the scope of the purpose of the present disclosure, all components may be selectively combined in one or more and operate accordingly. Unless otherwise defined, all terms including technical or scientific terms have the same meanings as commonly understood by those skilled in the art to which the present disclosure pertains. Commonly used terms, such as those defined in dictionaries, should be interpreted in accordance with the contextual meaning in the relevant technical field, and unless explicitly defined in the present disclosure, shall not be interpreted in an idealized or unduly formal sense.

The above description is merely illustrative of the technical spirit of the present disclosure, and it will be appreciated by those skilled in the art to which the present disclosure pertains that various modifications and alterations can be made without departing from the essential characteristics of the present disclosure. Therefore, the embodiments disclosed herein are intended to describe, not to limit, the technical spirit of the present disclosure, and the scope of the technical spirit is not limited to these embodiments. The scope of protection of the present disclosure shall be defined by the following claims, and all technical ideas that fall within the equivalent scope shall be construed as being comprised within the scope of the present disclosure.

What is claimed is:

1. A secondary battery comprising:
a battery can configured to accommodate an electrode assembly; and
a cap plate coupled to one side of the battery can,
wherein the cap plate is in contact with and electrically connected to the battery can.

2. The secondary battery according to claim 1, further comprising a first electrode terminal disposed in a direction opposite to the opening part of the battery can based on the electrode assembly,
wherein the cap plate forms a second electrode terminal having a different polarity from that of the first electrode terminal.

3. The secondary battery according to claim 1, wherein the battery can comprises a crimping part bent such that at least a partial section of a side wall thereof encloses at least a partial section of the cap plate.

4. The secondary battery according to claim 3, wherein the cap plate comprises:
a body part disposed to cover an opening part of the battery can; and
an edge part extending upward along a periphery of the body part and contacting the battery can.

5. The secondary battery according to claim 4, wherein the crimping part is disposed to enclose at least a portion of the edge part.

6. The secondary battery according to claim 4, wherein the edge part is bent one or more times.

7. The secondary battery according to claim 4, wherein the edge part comprises:
a first edge part extending upward from the body part; and
a second edge part bent inward from the first edge part and at least partly enclosed by the crimping part.

8. The secondary battery according to claim 7, wherein the crimping part comprises:
a first horizontal part in contact with an upper surface of the second edge part;
a vertical part extending downward from the first horizontal part; and
a second horizontal part bent from the vertical part toward the side wall of the battery can and in contact with a lower surface of the first edge part.

9. The secondary battery according to claim 8, wherein the second horizontal part is in contact with an inner surface of the first edge part.

10. The secondary battery according to claim 8, further comprising a sealing gasket disposed between the body part and the crimping part.

11. The secondary battery according to claim 10, wherein the sealing gasket is in contact with the second horizontal part of the crimping part.

12. The secondary battery according to claim 10, wherein the sealing gasket is disposed along an inner circumference of the edge part.

13. The secondary battery according to claim 10, wherein the sealing gasket comprises a ring shape.

14. The secondary battery according to claim 10, wherein the sealing gasket is pressed by the crimping part.

15. A crimping device comprising:
a mold support device; and
a crimping mold lowered by the mold support device to apply a pressing force to an opening part of a battery can,
wherein the crimping mold presses the battery can such that at least a partial section of the side wall of the battery can and at least a partial section of a cap plate disposed in the opening part of the battery can are bent.

16. The crimping device according to claim 15, wherein the crimping mold comprises:
a first mold configured to press an open end part of the side wall of the battery can to pre-form the side wall; and
a second mold configured to press the pre-formed side wall of the battery can to form a crimping part.

17. The crimping device according to claim 16, wherein the crimping mold further comprises a third mold configured to press the crimping part to compress a sealing gasket disposed on an upper portion of the cap plate.

18. The crimping device according to claim 16, wherein the first mold comprises a pre-forming part formed on a lower surface thereof to have an upwardly concave curved surface in a vertical cross-section, and
at least a partial section of the curved surface comprises a direction-changing part configured to guide the open end part of the side wall of the battery can to be bent downward.

19. The crimping device according to claim 18, wherein the pre-forming part comprises a semicircular shape in the vertical cross-section.

20. A crimping method comprising:
a preparation step of sequentially placing a cap plate and a sealing gasket on one side of a battery can;
a first crimping step of pre-forming at least a partial section of a side wall of the battery can and at least a partial section of the cap plate to be bent together;
a second crimping step of forming a crimping part such that the pre-formed side wall of the battery can is joined while enclosing the bent section of the cap plate, and the scaling gasket is disposed between an unbent section of the cap plate and the crimping part; and
a third crimping step of pressing the crimping part to compress the scaling gasket by the crimping part.
